(19) United States
(12) Patent Application Publication
(10) Pub. No.: US 2026/0273661 A1
(43) Pub. Date: Sep. 17, 2026

(54) FIBER PREFORM WITH WELD VOLUMES WELDING INNER PREFORM TUBES AND AN OUTER PREFORM CLADDING TOGETHER, AND METHOD OF MAKING THE SAME USING LASER PREHEATING AND LASER WELDING STEPS

(71) Applicant: CORNING INCORPORATED, CORNING, NY (US)

(72) Inventors: Anatoli Anatolyevich Abramov, Painted Post, NY (US); Christopher Charles Chilson, Wellsboro, PA (US); Bernard Leo Mark, Prattsburgh, NY (US)

(21) Appl. No.: 19/563,250

(22) Filed: Mar. 11, 2026

Related U.S. Application Data
(60) Provisional application No. 63/771,260, filed on Mar. 13, 2025.

(51) Int. Cl. B23K 26/21; B23K 26/08; B23K 26/57; B23K 26/70; B23K 101/06; B23K 103/00

(52) U.S. Cl. CPC B23K 26/21; B23K 26/083; B23K 26/57; B23K 26/702; B23K 2101/06; B23K 2103/50

(57) ABSTRACT

A method of manufacturing a fiber preform including: (1) a laser preheating step including directing a preheating emission from a laser into an outer preform cladding and an inner preform tube of a preform workpiece, the inner preform tube disposed at least partially within the outer preform cladding, to increase temperature within a preheating volume that extends into both the outer preform cladding and the inner preform tube; and (2) a laser welding step including directing a welding emission from the laser into the preheating volume to further increase temperature and decrease viscosity within a weld volume that, upon decreasing in temperature, welds the outer preform cladding and the inner preform tube together, wherein, the weld volume of the laser welding step at least partially overlaps with the preheating volume of the laser preheating step. Aspects of the fiber preform are additionally disclosed.

This application claims the benefit of priority to U.S. Provisional Patent Application Ser. No. 63/771,260 filed on Mar. 13, 2025, the content of which is relied upon and incorporated herein by reference in its entirety.

### TECHNICAL FIELD

The present disclosure pertains to a hollow core optical fiber preform and a method of making the same and, more particularly, to such a hollow core optical fiber preform with characteristically shaped weld volumes welding inner preform tubes to an outer preform cladding and such a method of making the same via a laser preheating step, a laser welding step, and optionally a laser annealing step.

### BACKGROUND

An optical fiber can be utilized to transmit an electromagnetic radiation signal across a distance. In a traditional design, the optical fiber includes a solid core through which the signal transmits and a solid cladding disposed radially around the solid core. The solid core and the solid cladding have different indices of refraction. The signal thus largely stays confined within the solid core during transmission because of total internal reflection at the interface between the solid core and the solid cladding. The utilization of the solid core limits the speed at which the optical fiber can transmit the signal (e.g., an inherent minimum latency), limits the power of the signal that can be transmitted, imposes a degree of attenuation of the signal, and introduces non-linear effects such as four-wave mixing.

To address the limitations of the solid core based optical fiber, optical fibers with a hollow core have been proposed. With such an optical fiber, there is no solid core but rather a hollow core. Various ways of maintaining the signal within the hollow core have been utilized-one of which is anti-resonance. With anti-resonance, the cladding is engineered with the operating wavelength of the signal in mind so that the cladding reflects the signal back into the hollow core and largely prevents transmission of the signal through the cladding. An example of such a cladding are hollow tubes that run axially with the transmission axis through the hollow core. The hollow tubes are placed radially around the transmission axis to define the hollow core and have a thickness at which the hollow tubes do not resonate with the signal but rather reflect the signal to maintain the signal within the hollow core. Such optical fibers are typically referred to as anti-resonant hollow core optical fibers or ARFs for short.

Techniques to manufacture ARFs are under development. However, like solid core optical fibers, the techniques typically include drawing the ARF from a preform that is structurally similar to the ARF but with thicker components. Fabrication of the preform may require precise spatial placement of the preform cladding tubes relative to each other and a surrounding outer cladding. To obtain and maintain the precise spatial placement, it has been proposed to weld the preform cladding tubes and the surrounding outer cladding together, such as at both longitudinal ends of the preform. An open flame and laser emission have been attempted to perform the welding of the components.

However, welding components to make the preform causes various problems. First, the welding process generates residual stress within the components. The residual stress can cause one or more of the components to crack over time. Further handling of the preform can accelerate the development of cracks from the residual stress.

Second, use of the open flame can cause particle deposition on the preform components such as the preform cladding tubes and the preform outer cladding tube. As the open flame causes the preform components to increase in temperature, particles of material such as silica soot and contaminants are released. The particles then deposit elsewhere on the components. The deposition of the particles is problematic because the particles may cause the optical fiber ultimately drawn from the preform to exhibit suboptimal transmission and mechanical performance. The particles could be removed from the preform before draw of the optical fiber. However, such remediation efforts are difficult to perform and, in any event, suboptimal in terms of cost and time.

Third, the use of the open flame poses additional problems in that the preform components can become distorted, a consequence of the open flame heating a relatively large volume of the preform components. The distortion can cause the preform components to become out of predetermined dimensional tolerances. The preform may then need to be scrapped. Even if not, the change in dimensional tolerances may be carried over to the optical fiber drawn from the preform. The change in dimension tolerances would negatively impact optical performance of the optical fiber drawn from the preform.

### SUMMARY

The present disclosure addresses those problems, in a variety of ways. Among them, disclosed herein is a method of making a fiber preform that includes a laser preheating step to bring the material to be welded together closer to the softening temperature thereof before conducting a laser welding step, which then welds the components together at a weld volume. The laser preheating step reduces the level of stress in and at the weld volume compared to if no laser preheating step were used. To further reduce stress in and at the weld volume, the method can further include a laser annealing step, which raises the temperature in and at the weld volume to above the annealing temperature thereof. Further, the method does not use an open flame, rather only a laser is utilized. Thus, the contamination issues arising from the use of an open flame to weld are avoided. Similarly, because an open flame is not utilized, distortion of the components is avoided.

According to a first aspect of the present disclosure, a fiber preform comprises (a) a first end, a second end, a longitudinal axis extending from the first end to the second end; (b) an outer preform cladding through which the longitudinal axis extends, the outer preform cladding comprising an inner surface disposed radially around the longitudinal axis; (c) inner preform tubes welded to the outer preform cladding at the inner surface of the outer preform cladding, wherein each of the inner preform tubes comprises (i) a tube axis extending therethrough parallel to the longitudinal axis of the fiber preform, (ii) an inner surface extending radially around the tube axis, and (iii) an outer surface facing away from the tube axis, and wherein the inner preform tubes collectively define a preform core that extends radially from the longitudinal axis and that is tangential to the outer surfaces of the inner preform tubes; and (d) first weld volumes, each of the first weld volumes welding a different one of the inner preform tubes to the outer preform cladding proximate the first end of the fiber preform; wherein, each of the first weld volumes has a vortex or conical shape.

According to a second aspect of the present disclosure, the fiber preform of the first aspect is presented, wherein (i) the outer preform cladding further comprises a cladding thickness, (ii) each of the inner preform tubes comprise a tube thickness, and (iii) the cladding thickness is greater than the tube thickness.

According to a third aspect of the present disclosure, the fiber preform of the second aspect is presented, wherein (i) the cladding thickness is within a range of from 3 mm to 100 mm, and (ii) the tube thickness is within a range of from 0.5 mm to 2.0 mm.

According to a fourth aspect of the present disclosure, the fiber preform of any one of the first through third aspects further comprises: additional first weld volumes, each of the additional first weld volumes welding a different one of the inner preform tubes to the outer preform cladding proximate the first end of the fiber preform inward of the first end from the first weld volume closest thereto; wherein, each of the additional first weld volumes has a vortex or conical shape.

According to a fifth aspect of the present disclosure, the fiber preform of any one of the first through fourth aspects is presented, wherein the outer preform cladding and the inner preform tubes all comprise one or more of silica, doped silica, fluorine-doped silica, fluorine-doped borosilicate, borosilicate, soda-lime glass, and alumina-silicate.

According to a sixth aspect of the present disclosure, the fiber preform of any one of the first through fifth aspects is presented, wherein the vortex or conical shape of each of the first weld volumes extends toward a point inward from the first end of the fiber preform and away from the longitudinal axis.

According to a seventh aspect of the present disclosure, the fiber preform of any one of the first through sixth aspects further comprises preform capillaries disposed within the inner preform tubes, each of the preform capillaries disposed within a different one of the inner preform tubes, wherein each of the preform capillaries comprises (i) a capillary axis extending therethrough parallel to the longitudinal axis of the fiber preform, (ii) an inner surface extending radially around the capillary axis, and (iii) an outer surface facing away from the tube axis, wherein, each of the first weld volumes further welds a different one of the preform capillaries to the inner preform tube within which the preform capillary is disposed proximate the first end of the fiber preform.

According to an eighth aspect of the present disclosure, the fiber preform of the seventh aspect is presented, wherein the preform capillary comprises a capillary thickness that is within 10% of the tube thickness of the inner preform tube.

According to a ninth aspect of the present disclosure, the fiber preform of any one of the first through eighth aspects further comprises second weld volumes, each of the second weld volumes welding a different one of the inner preform tubes to the outer preform cladding proximate the second end of the fiber preform, wherein, each of the second weld volumes has a vortex or conical shape.

According to a tenth aspect of the present disclosure, the fiber preform of the ninth aspect is presented, wherein the vortex or conical shape of each of the second weld volumes extends toward a point inward from the second end of the fiber preform and away from the longitudinal axis.

According to an eleventh aspect of the present disclosure, the fiber preform of any one of the ninth through tenth aspects further comprises: (a) additional first weld volumes, each of the additional first weld volumes welding a different one of the inner preform tubes to the outer preform cladding proximate the first end of the fiber preform inward of the first end from the first weld volume closest thereto; and (b) additional second weld volumes, each of the additional second weld volumes welding a different one of the inner preform tubes to the outer preform cladding proximate the second end of the fiber preform inward of the second end from the second weld volume closest thereto, wherein (i) each of the additional first weld volumes has a vortex or conical shape, and (ii) each of the additional second weld volumes has a vortex or conical shape.

According to a twelfth aspect of the present disclosure, the fiber preform of any one of the ninth through eleventh aspects is presented, wherein (i) the vortex or conical shape each of the additional first weld volumes extends toward a point inward from the first end of the fiber preform and away from the longitudinal axis, and (ii) the vortex or conical shape of each of the additional second weld volumes extends toward a point inward from the second end of the fiber preform and away from the longitudinal axis.

According to a thirteenth aspect of the present disclosure, the fiber preform of any one of the ninth through twelfth aspects further comprises: preform capillaries disposed within the inner preform tubes, each of the preform capillaries disposed within a different one of the inner preform tubes, wherein each of the preform capillaries comprises (i) a capillary axis extending therethrough parallel to the longitudinal axis of the fiber preform, (ii) an inner surface extending radially around the capillary axis, and (iii) an outer surface facing away from the tube axis, wherein (i) each of the first weld volumes further welds a different one of the preform capillaries to the inner preform tube within which the preform capillary is disposed proximate the first end of the fiber preform, and (ii) each of the second weld volumes further welds a different one of the preform capillaries to the inner preform tube within which the preform capillary is disposed proximate the second end of the fiber preform.

According to a fourteenth aspect of the present disclosure, a method of manufacturing a fiber preform comprises: (a) a laser preheating step comprising directing a preheating emission from a laser into an outer preform cladding and an inner preform tube of a preform workpiece, the inner preform tube disposed at least partially within the outer preform cladding, to increase temperature within a preheating volume that extends into both the outer preform cladding and the inner preform tube; and (b) a laser welding step, occurring after the laser preheating step, the laser welding step comprising directing a welding emission from the laser into the preheating volume to further increase temperature and decrease viscosity within a weld volume that, upon decreasing in temperature, welds the outer preform cladding and the inner preform tube together, wherein, the weld volume of the laser welding step at least partially overlaps with the preheating volume of the laser preheating step.

According to a fifteenth aspect of the present disclosure, the method of the fourteenth aspect is presented, wherein (i) the laser preheating step occurs throughout a preheating period of time, and (ii) the preheating period of time is within a range of from 1 second to 10 seconds.

According to a sixteenth aspect of the present disclosure, the method of any one of the fourteenth through fifteenth aspects is presented, wherein the laser has a position relative to the preform workpiece that is substantially the same throughout the laser preheating step and the laser welding step.

According to a seventeenth aspect of the present disclosure, the method of any one of the fourteenth through sixteenth aspects is presented, wherein the laser emits the welding emission with greater power than the preheating emission.

According to an eighteenth aspect of the present disclosure, the method of any one of the fourteenth through seventeenth aspects is presented, wherein focusing optics utilized to manipulate the preheating emission are altered to manipulate the welding emission.

According to a nineteenth aspect of the present disclosure, the method of any one of the fourteenth through eighteenth aspects is presented, wherein (i) the laser welding step occurs throughout a welding period of time that is greater than the preheating period of time, and (ii) the welding period of time is within a range of from 5 seconds to 40 seconds.

According to a twentieth aspect of the present disclosure, the method of any one of the fourteenth through nineteenth aspects is presented, wherein (i) the laser emits the welding emission with a power of less than 170 W, and (ii) the welding emission from the laser has a wavelength of peak intensity that is within a range of from 5 μm to 11 μm.

According to a twenty-first aspect of the present disclosure, the method of any one of the fourteenth through twentieth aspects is presented, wherein upon the decreasing in temperature, the weld volume has a vortex or conical shape.

According to a twenty-second aspect of the present disclosure, the method of any one of the fourteenth through twenty-first aspects further comprises a laser annealing step, occurring after the laser welding step, the laser annealing step comprising directing an annealing emission from the laser into an annealing volume that at least partially overlaps the weld volume of the laser welding step, the annealing emission maintaining a temperature of material within the annealing volume to above an annealing temperature but below a softening temperature.

According to a twenty-third aspect of the present disclosure, the method of the twenty-second aspect is presented, wherein (i) the outer preform cladding proximate the weld volume exhibits a first stress after the laser welding step but before the laser annealing step, (ii) the outer preform cladding proximate the weld volume exhibits a second stress after the laser annealing step, and (iii) the second stress is less than the first stress.

According to a twenty-fourth aspect of the present disclosure, the method of any one of the twenty-second through twenty-third aspects is presented, wherein (i) the laser preheating step occurs throughout a preheating period of time, (ii) the laser welding step occurs throughout a welding period of time, (iii) the laser annealing step occurs throughout an annealing period of time that is greater than the preheating period of time and greater than the welding period of time, (iv) the annealing period is within a range of from 60 seconds to 90 seconds, and (v) the annealing emission from the laser has a wavelength of peak intensity that is within a range of from 5 μm to 11 μm.

According to a twenty-fifth aspect of the present disclosure, the method of any one of the twenty-second through twenty-fourth aspects is presented, wherein the laser has a position relative to the preform workpiece that is substantially the same throughout the laser preheating step, the laser welding step, and the laser annealing step.

According to a twenty-sixth aspect of the present disclosure, the method of any one of the twenty-second through twenty-fifth aspects is presented, wherein the laser emits the annealing emission with greater power than both the preheating emission and the welding emission.

According to a twenty-seventh aspect of the present disclosure, the method of any one of the twenty-second through twenty-sixth aspects is presented, wherein focusing optics utilized to manipulate the welding emission are altered to manipulate the annealing emission so that the annealing emission is wider than the welding emission.

According to a twenty-eighth aspect of the present disclosure, the method of the twenty-seventh aspect is presented, wherein the laser emits the annealing emission with greater power than both the preheating emission and the welding emission.

According to a twenty-ninth aspect of the present disclosure, the method of any one of the twenty-second through twenty-eighth aspects is presented, wherein (i) the fiber preform workpiece comprises a longitudinal axis extending through the outer preform cladding, (ii) the inner preform tube comprises a tube axis that is substantially parallel to the longitudinal axis of the fiber preform workpiece, and (iii) the preheating emission, the welding emission, and the annealing emission all impinge upon the preform workpiece at an angle that is acute and not orthogonal relative to the longitudinal axis and the tube axis.

According to a thirtieth aspect of the present disclosure, the method of any one of the twenty-second through twenty-eighth aspects further comprises: (a) a translating step comprising translating the preform workpiece relative to the laser so that an additional first weld volume resulting from a repeat performance of the laser welding step would be disposed proximate the first end of the fiber preform workpiece inward of the first end from the first weld volume closest thereto; and (b) repeating performances of (i) the laser preheating step, (ii) the laser welding step to form the additional first weld volume inward from the first weld volume, and (iii) the laser annealing step.

According to a thirty-first aspect of the present disclosure, the method of the thirtieth aspect further comprises repeating cycles of the laser preheating step, the laser welding step, the annealing step, and the translating step as necessary to form a second weld volume at least one additional second weld volume inward of the second weld volume that weld the outer preform cladding and the inner preform together proximate a second end of the fiber preform workpiece.

According to a thirty-second aspect of the present disclosure, a method of manufacturing a fiber preform comprises: (a) a laser welding step comprising directing a welding emission from a laser into an outer preform cladding and an inner preform tube of a preform workpiece, the inner preform tube disposed at least partially within the outer preform cladding, to increase temperature within a weld volume that extends into both the outer preform cladding and the inner preform tube; and (b) a laser annealing step, occurring after the laser welding step, the laser annealing step comprising directing an annealing emission from the laser into an annealing volume that at least partially overlaps the weld volume of the laser welding step, the annealing emission maintaining a temperature of material within the annealing volume to above an annealing temperature but below a softening temperature.

According to a thirty-third aspect of the present disclosure, the method of the thirty-second aspect is presented, wherein (i) the outer preform cladding proximate the weld volume exhibits a first stress after the laser welding step but before the laser annealing step, (ii) the outer preform cladding proximate the weld volume exhibits a second stress after the laser annealing step, and (iii) the second stress is less than the first stress.

According to a thirty-fourth aspect of the present disclosure, the method of any one of the thirty-second through thirty-third aspects is presented, wherein (i) the laser welding step occurs throughout a welding period of time, (ii) the laser annealing step occurs throughout an annealing period of time that greater than the welding period of time, (iii) the annealing period is within a range of from 60 seconds to 90 seconds, and (iv) the annealing emission from the laser has a wavelength of peak intensity that is within a range of from 5 μm to 11 μm.

According to a thirty-fifth aspect of the present disclosure, the method of any one of the thirty-second through thirty-fourth aspects is presented, wherein the laser emits the annealing emission with greater power than the welding emission.

According to a thirty-sixth aspect of the present disclosure, the method of any one of the thirty-second through thirty-fifth aspects is presented, wherein focusing optics utilized to manipulate the welding emission are altered to manipulate the annealing emission so that the annealing emission is wider than the welding emission.

According to a thirty-seventh aspect of the present disclosure, the method of any one of the thirty-second through thirty-sixth aspects is presented, wherein upon a decrease in temperature from the annealing temperature the weld volume has a vortex or conical shape.

According to a thirty-eighth aspect of the present disclosure, an anti-resonant hollow core optical fiber drawn from the fiber preform of any one of the first through tenth aspects or the fiber preform made according to the method of any one of the fourteenth through thirty-seventh aspects.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of a fiber preform of the present disclosure (and also a preform workpiece, a precursor to the fiber preform), illustrating inner preform tubes disposed within (and as will be explained, for the fiber preform, welded to) an outer preform cladding;

FIG. 2 is an elevational view of a first end of the fiber preform (and also the preform workpiece), illustrating a longitudinal axis around which the outer preform cladding is disposed and around which the inner preform tubes are arranged;

FIG. 3 is an elevational view of a cross-section of the fiber preform taken along line III-III of FIG. 2, illustrating (i) a first weld volume and additional first weld volumes proximate the first end of the fiber preform attaching one of the inner preform tubes and the outer preform cladding together and (ii) a second weld volume and additional second weld volumes proximate the second end of the fiber preform attaching one of the inner preform tubes and the outer preform cladding together;

FIG. 4 is the same as FIG. 3 but illustrating an embodiment where a preform capillary is disposed within the inner preform tube, and the first weld volume, the additional first weld volumes, the second weld volume, and the additional second weld volumes attach the preform capillary, the inner preform tube, and the outer preform cladding together;

FIG. 5 is a schematic diagram of a method of making the fiber preform, illustrating a laser preheating step, a laser welding step, and a laser annealing step, among other possible steps;

FIG. 6 is an elevational view of a cross-section of the preform workpiece being subjected to the laser preheating step, illustrating a laser generating a preheating emission that focusing optics direct at an angle (relative to the longitudinal axis) into both the inner preform tube and the outer preform cladding and increasing temperature within a preheating volume;

FIG. 7 is like FIG. 6 but this time the laser welding step is being conducted, with the laser generating a welding emission that the focusing optics direct into the preheating volume (still at an increased temperature) to form a weld volume (e.g., a first weld volume as mentioned above), thus forming the fiber preform;

FIG. 8 follows FIGS. 6 and 7 in chronology showing the laser annealing step being conducted, with the laser generating an annealing emission that the focusing optics direct into an annealing volume at least partially overlapping the weld volume to relieve stress that the laser welding step may have imparted;

FIG. 9, pertaining to Comparative Example 1, illustrates a laser generating a weld volume but without any preceding laser preheating step having been conducted;

FIG. 10, again pertaining to Comparative Example 1, is a graph plotting the power of the laser as a function of time, illustrating only the laser welding step having been performed;

FIG. 11, again pertaining to Comparative Example 1, is an image of a crack having formed shortly after the formation of three such weld volumes, presumably because of excess residual stress after weld formation;

FIG. 12, pertaining to Comparative Example 2, is an image of a crack having formed after 24 hours after the formation of three weld volumes, all of which were subjected to a short laser annealing step but no laser preheating step;

FIG. 13, pertaining to Example 1, is a graph plotting laser power as a function of time, illustrating that a laser preheating step was conducted at a relative medium power, a laser welding step was conducted at relative high power, and a laser annealing step was conducted at a relatively low power but for a relatively longer period of time;

FIG. 14, again pertaining to Example 1, is an image of three welded areas (and no associated cracks) at one end of the fiber preform, all of which were made in the sequence of the laser preheating step, the laser welding step, and the laser annealing step;

FIG. 15, pertaining to Examples 2-4, is a graph plotting laser power as a function of time, illustrating (in connection with Example 2) that when successive welds are formed, the power can be increased for the welding emission because each successive weld is formed further from the laser, and (in connection with Examples 3 and 4) that the laser annealing steps can be either relatively short or relatively long;

FIG. 16, pertaining to Example 5, is a graph again plotting laser power as a function of time, illustrating that the laser annealing step can utilize a lower power for the annealing emission (relative to the preheating emission and the welding emission) without having to adjust focusing optics or a higher power for the annealing emission after adjusting the focusing optics to enlarge the annealing emission and thus the annealing volume subjected to the annealing emission (due to spreading the energy over a greater volume);

FIG. 17, pertaining to Example 6, are images of a fiber preform of the present disclosure with at the left the full length depicted between the first end and the second end, in the center a closer up view of the first end showing weld volumes attaching each of the inner preform tubes to the outer preform cladding, and finally at the right a magnified view of a pair of weld volumes attaching one of the inner preform tubes to the outer preform cladding at the first end of the fiber preform (notice the characteristic vortex or conical shape of the weld volumes);

FIG. 18, pertaining to Example 7, are images of another fiber preform of the present disclosure with at the left the full length depicted between the first end and the second end, at the right a closer up view of the first end showing weld volumes attaching each of the inner preform tubes to the outer preform cladding along with a capillary tube within each inner preform tube, and in the center a magnified view of a triplet of weld volumes attaching one of the capillary tubes and one of the inner preform tubes simultaneously to the outer preform cladding at the first end of the fiber preform (notice the characteristic vortex or conical shape of the weld volumes); and

FIGS. 19-21, pertaining to Examples 8-10, are each an image captured by an infrared temperature sensor during a performance of the laser annealing step showing temperature around the weld area subjected to the annealing emission.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

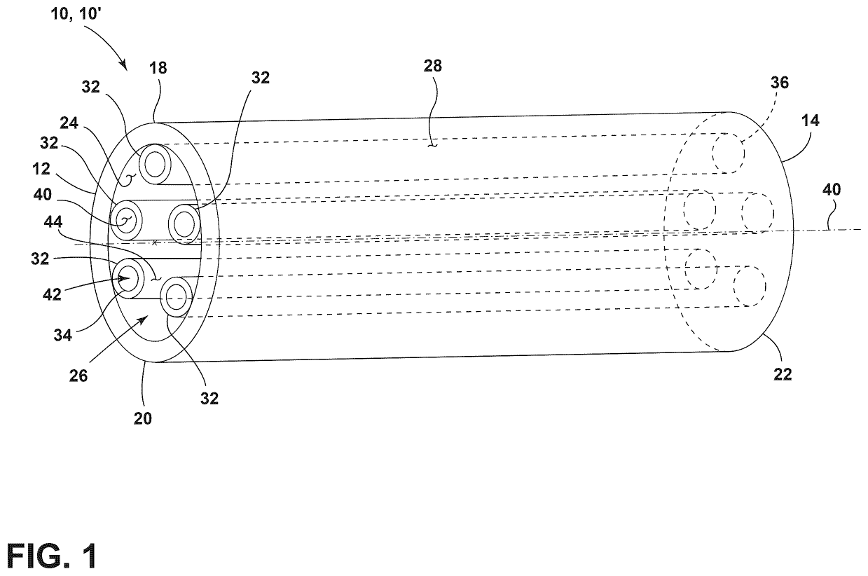

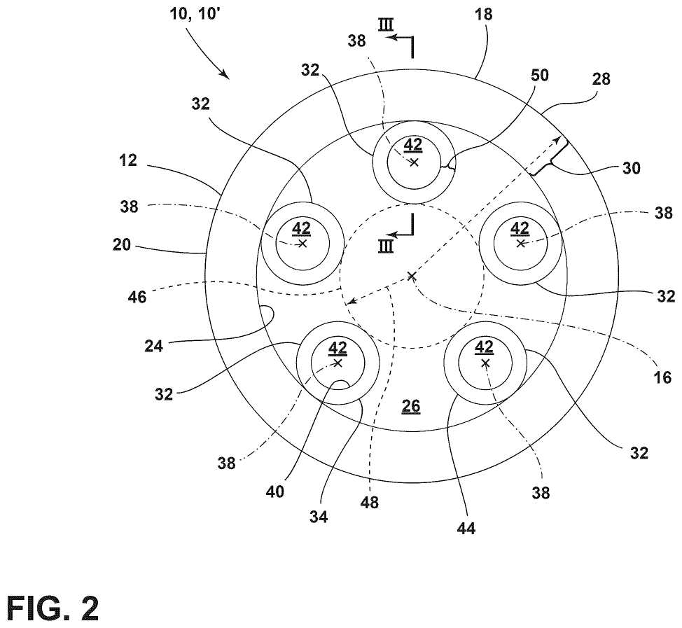

Referring to FIGS. 1-2, a fiber preform 10 of the present disclosure is herein disclosed. The fiber preform 10 includes a first end 12 and a second end 14. The first end 12 and the second end 14 face in opposite directions. The fiber preform 10 further includes a longitudinal axis 16 that extends from the first end 12 to the second end 14.

The fiber preform 10 further includes an outer preform cladding 18. The longitudinal axis 16 extends through the outer preform cladding 18. The outer preform cladding 18 has a first end 20 that may define at least in part the first end 12 of the fiber preform 10. The outer preform cladding 18 has a second end 22 that may define at least in part the second end 14 of the fiber preform 10. The outer preform cladding 18 provides an inner surface 24 that is disposed radially from the longitudinal axis 16. The inner surface 24 defines a cladding interior 26 through which the longitudinal axis 16 extends. The outer preform cladding 18 further includes an outer surface 28 that faces away from the longitudinal axis 16. The outer preform cladding 18 further includes a cladding thickness 30 that is measured radially relative to the longitudinal axis 16 between the inner surface 24 and the outer surface 28 of the outer preform cladding 18. In embodiments, the cladding thickness 30 is within a range of from 3 mm to 100 mm. For example, the cladding thickness 30 can be 3 mm, 5 mm, 7 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 95 mm, 100 mm, or within any range bound by any two of those values (e.g., from 5 mm to 15 mm, from 15 mm to 30 mm, and so on). The cladding thickness 30 could be less than 3 mm or greater than 100 mm, however—the provided values are just exemplary.

The fiber preform 10 further includes inner preform tubes 32. The inner preform tubes 32 are at least partially disposed within the cladding interior 26 of the outer preform cladding 18. As will be discussed in greater detail herein, inner preform tubes 32 are welded to the outer preform cladding 18 at the inner surface 24 of the outer preform cladding 18. Each of the inner preform tubes 32 has a first end 34 that may define at least in part the first end 12 of the fiber preform 10. Each of the inner preform tubes 32 has a second end 36 that may define at least in part the second end 14 of the fiber preform 10. Each of the inner preform tubes 32 has a tube axis 38 extending therethrough that is parallel to the longitudinal axis 16 of the fiber preform 10. Each of the inner preform tubes 32 provides an inner surface 40 that is disposed radially around the tube axis 38 thereof. The inner surface 40 defines a tube interior 42 through which the tube axis 38 extends. Each of the inner preform tubes 32 provides an outer surface 44 that faces away from the tube axis 38 thereof. The inner surface 40 and the outer surface 44 of each of the inner preform tubes 32 can extend from the tube axis 38 thereof at constant radiuses (not separately illustrated). The inner preform tubes 32 collectively define a preform core 46. The preform core 46 extends radially around the longitudinal axis 16 at a core radius 48. The preform core 46 is tangential to the outer surfaces 44 of the inner preform tubes 32. The inner preform tubes 32 may be equidistantly spaced from each other.

Each of the inner preform tubes 32 has a tube thickness 50, which may all be the same. The tube thickness 50 is measured radially relative to the tube axis 38 between the inner surface 40 and the outer surface 44 of the inner preform tube 32. In embodiments, the cladding thickness 30 is greater than the tube thickness 50. In embodiments, the tube thickness 50 is within a range of from 0.5 mm to 2.0 mm. For example, the tube thickness 50 can be 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, or within any range bound by any two of those values (e.g., from 0.7 mm to 1.5 mm, from 0.8 mm to 1.6 mm, and so on). The tube thickness 50 can be less than 0.5 mm or greater than 2.0 mm, however—those values are merely exemplary.

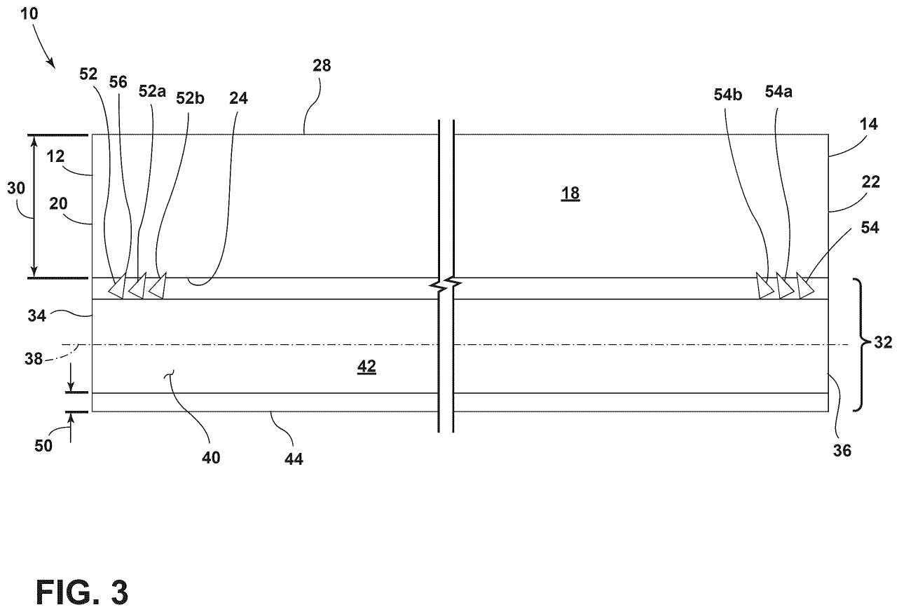

Referring now to FIG. 3, the fiber preform 10 further includes first weld volumes 52 and second weld volumes 54 that weld the inner preform tubes 32 to the outer preform cladding 18 within the cladding interior 26. Each of the first weld volumes 52 weld a different one of the inner preform tubes 32 to the outer preform cladding 18 proximate the first end 12 of the fiber preform 10. Each of the second weld volumes 54 weld a different one of the inner preform tubes 32 to the outer preform cladding 18 proximate the second end 14 of the fiber preform 10. As will be detailed herein, the first weld volumes 52 and the second weld volumes 54 constitute material from the components of the fiber preform 10 (e.g., inner preform tubes 32 and the outer preform cladding 18), with the material having been induced via emission from a laser (introduced below) to increase in temperature, soften, and then cool as the first weld volumes 52 and the second weld volumes 54. The use of the emission from the laser results in each of the first weld volumes 52 and the second weld volumes 54 taking a characteristic shape and appearance. More particularly, each of the first weld volumes 52 have a vortex or conical shape preferably extending to a point 56 inward from the first end 12 of the fiber preform 10 and away from the longitudinal axis 16. Similarly, each of the second weld volumes 54 have a vortex or conical shape preferably extending to a point 56 inward from the second end 14 of the fiber preform 10 and away from the longitudinal axis 16.

In embodiments, the fiber preform 10 further includes additional first weld volumes 52a, 52b, . . . 52n and additional second weld volumes 54a, 54b, . . . 54n to enhance the welding of the inner preform tubes 32 and the outer preform cladding 18 together. Each of the additional first weld volumes 52a, 52b, . . . 52n weld a different one of the inner preform tubes 32 to the outer preform cladding 18 proximate the first end 12 of the fiber preform 10 inward of the first end 12 from the first weld volume 52 closest thereto. For example, in reference to the FIG. 3A, the first weld volume 52 is disposed closest to the first end 12 of the fiber preform 10, the additional first weld volume 52a is disposed inward longitudinally along the longitudinal axis 16 from the first weld volume 52, and the additional first weld volume 52b is disposed inward longitudinally along the longitudinal axis 16 from the additional first weld volume 52a. The first weld volume 52 and the additional first weld volumes 52a, 52b, . . . 52n may thus collectively form weld doublets, weld triplets (as illustrated), and so on welding each of the inner preform tubes 32 to the outer preform cladding 18. Like the first weld volumes 52, each of the additional first weld volumes 52a, 52b, . . . 52n have a vortex or conical shape preferably extending to a point 56 inward from the first end 12 of the fiber preform 10 and away from the longitudinal axis 16.

Each of the additional second weld volumes 54a, 54b, . . . 54n weld a different one of the inner preform tubes 32 to the outer preform cladding 18 proximate the second end 14 of the fiber preform 10 inward of the second end 14 from the second weld volume 54 closest thereto. For example, in reference to the FIG. 3B, the second weld volume 54 is disposed closest to the second end 14 of the fiber preform 10, the additional second weld volume 54a is disposed inward longitudinally along the longitudinal axis 16 from the second weld volume 54, and the additional second weld volume 54b is disposed inward longitudinally along the longitudinal axis 16 from the additional second weld volume 54a. The second weld volume 54 and the additional second weld volumes 54a, 54b, . . . 54n may thus collectively form weld doublets, weld triplets (as illustrated), and so on welding each of the inner preform tubes 32 to the outer preform cladding 18 at the second end 14 of the fiber preform 10. Like the second weld volumes 54, each of the additional second weld volumes 54a, 54b, . . . 54n have a vortex or conical shape preferably extending to a point 56 inward from the second end 14 of the fiber preform 10 and away from the longitudinal axis 16.

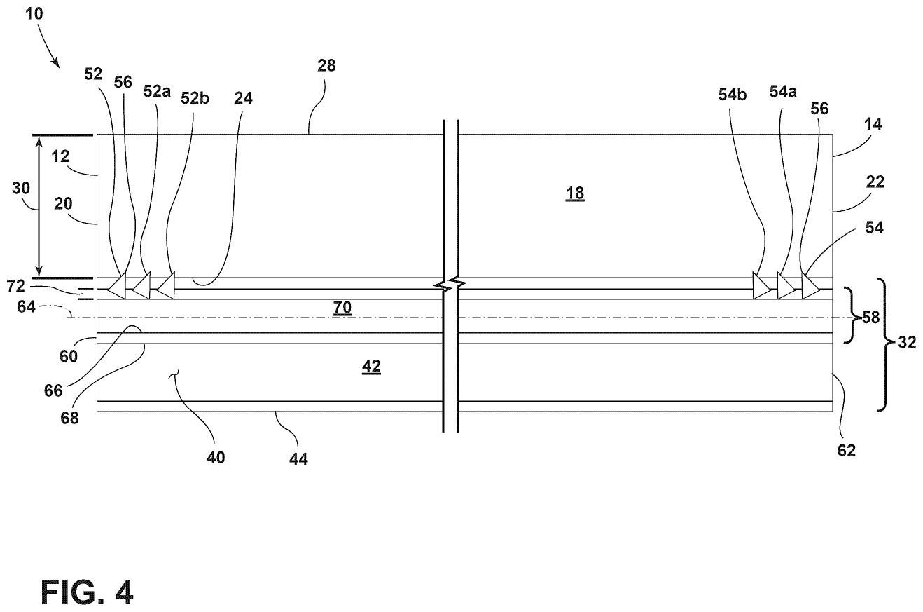

Referring now to FIG. 4, in embodiments, the fiber preform 10 further includes preform capillaries 58. The preform capillaries 58 are disposed within the inner preform tubes 32. More particularly, each of the preform capillaries 58 is disposed within the tube interior 42 of a different one of the inner preform tubes 32. Such an arrangement is sometimes referred to as a nested arrangement. Each of the preform capillaries 58 has a first end 60 that may define at least in part the first end 12 of the fiber preform 10. Each of the preform capillaries 58 has a second end 62 that may define at least in part the second end 14 of the fiber preform 10. Each of the preform capillaries 58 includes a capillary axis 64 extending therethrough. The capillary axis 64 is parallel to the longitudinal axis 16 of the fiber preform 10 and thus the tube axis 38. Each of the preform capillaries 58 further includes an inner surface 66 and an outer surface 68. The inner surface 66 extends radially around the capillary axis 64 and defines a capillary channel 70, such as at a constant radius (not separately illustrated) from the capillary axis 64. The outer surface 68 faces away from the capillary axis 64, such as at a constant radius (not separately illustrated) from the capillary axis 64. Each of the preform capillaries 58 has a capillary thickness 72, which may all be the same. The capillary thickness 72 is measured radially relative to the capillary axis 64 between the inner surface 66 and the outer surface 68 of the preform capillary 58. In embodiments, the capillary thickness 72 is within 10% of the tube thickness 50 of the inner preform tube 32, and may be equal to the tube thickness 50 to the extent achievable under manufacturing tolerances.

Each of the first weld volumes 52, and if included the additional first weld volumes 52a, 52b, . . . 52n, further weld a different one of the preform capillaries 58 to the inner preform tube 32 within which the preform capillary 58 is disposed proximate the first end 12 of the fiber preform 10. Similarly, each of the second weld volumes 54, and if included the additional second weld volumes 54a, 54b, . . . 54n, further weld a different one of the preform capillaries 58 to the inner preform tube 32 within which the preform capillary 58 is disposed proximate the second end 14 of the fiber preform 10. As will be discussed, the emission from the laser forming the first weld volumes 52, the second weld volumes 54, the additional first weld volumes 52a, 52b, . . . 52n (if included), and the additional second weld volumes 54a, 54b, . . . 54n (if included) further heats and softens the material of the preform capillary 58 within the tube interior 42 of the inner preform tube 32 being welded to the outer preform cladding 18. Thus, the weld volume (e.g., first weld volume 52, as the case may be) encompasses material from all of the preform capillary 58, the inner preform tube 32, and the outer preform cladding 18, which results in the coupling of all three components.

It is worth noting here that anti-resonant hollow core optical fibers can take many configurations. While arrangements with equally spaced inner preform tubes 32 without preform capillaries 58 have been described, as well as a nested arrangement with the preform capillaries 58 within the inner preform tubes 32, other arrangements are certainly possible. For example, an additional smaller radius preform capillary (not separately illustrated) can be placed within each of the preform capillaries 58 to form a double nested arrangement. As another example, an additional preform capillary 58 can be placed within each of the inner preform tubes 32 next to the preform capillary 58 already described. Regardless of the arrangement used, the first weld volumes 52 or additional like weld volumes can couple the components together, without having to repeat the discussion for every possible arrangement.

In embodiments, the outer preform cladding 18, the inner preform tubes 32, the preform capillaries 58, and any additional component of the fiber preform 10 welded via the first weld volumes 52 and the second weld volumes 54 include one or more of silica, doped silica, fluorine-doped borosilicate, borosilicate, soda-lime glass, and alumina-silicate. In short, the welded components of the fiber preform 10 have a glass composition. The type of glass composition is not particularly important and the listed above is merely exemplary.

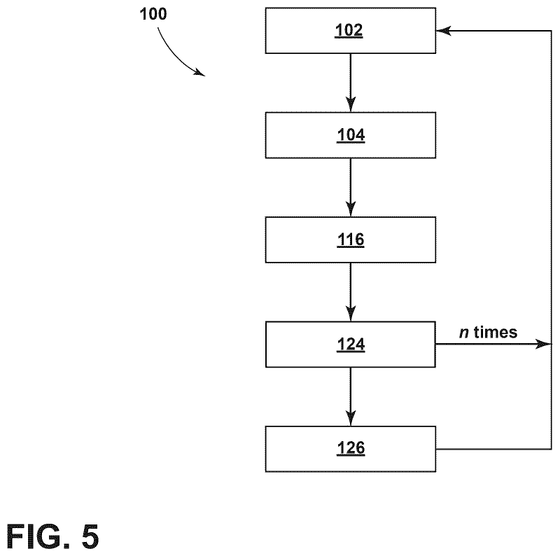

Referring now to FIGS. 5-8, a method 100 of manufacturing the fiber preform 10 from a preform workpiece 10′ is herein described. The preform workpiece 10′ is the same as the fiber preform 10 discussed above but lacking any welds yet (e.g., none of the first weld volumes 52 or the second weld volumes 54). The welding thereof to transform the preform workpiece 10′ to the fiber preform 10 is the subject of the method 100. The preform workpiece 10′ is not re-illustrated in the Drawings, except to the extent appropriate to explain the steps of the method 100.

The method 100 includes at least a laser welding step 104 and at least one of a laser preheating step 102 and a laser annealing step 116. The laser welding step 104 occurs after the laser preheating step 102, if present, and before the laser annealing step 116, if present.

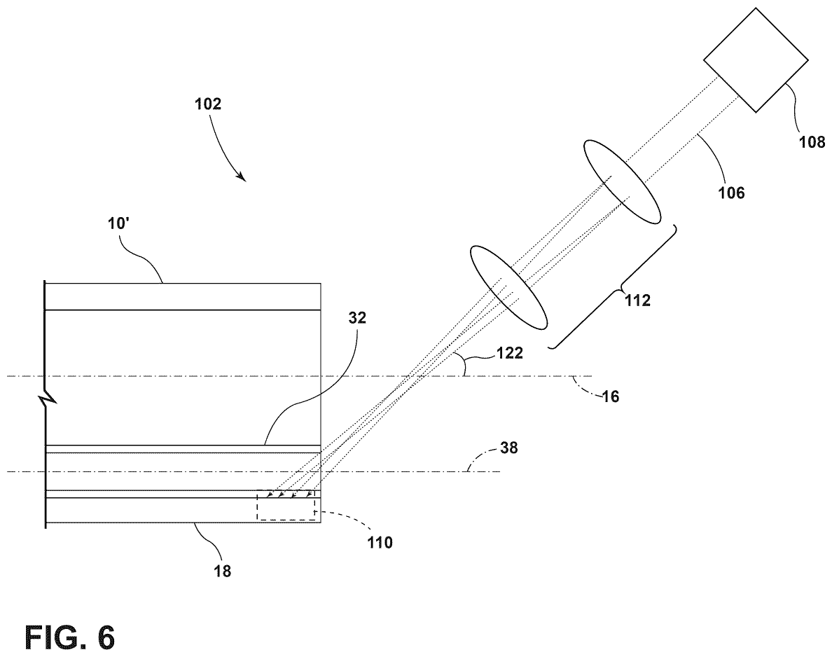

The laser preheating step 102 (see FIG. 6) includes directing a preheating emission 106 from a laser 108 into the outer preform cladding 18 and the inner preform tube 32 of the preform workpiece 10′. The preheating emission 106 from the laser 108 increases the temperature within a preheating volume 110 that extends into both the outer preform cladding 18 and the inner preform tube. The laser 108 is associated with focusing optics 112 that manipulate the preheating emission 106. The power of the laser 108 for the preheating emission 106, and the focusing optics 112, are configured in tandem so that the material within the preheating volume 110 is not increased in temperature up to the softening temperature (defined herein as the temperature at which the material has a viscosity of 10^{7.6} Poise). The temperature of the material within the preheating volume 110 is preferably above the annealing temperature (defined herein as the temperature at which the material has a viscosity of 10¹³ Poise) and again below the softening temperature. One purpose of the laser preheating step 102 is to preheat the material in anticipation of the subsequent laser welding step 104 of the method 100 where the temperature is raised to at least the softening temperature. By preheating the material where the weld will be formed, the thermal flux during the later welding step is less shocking to the components (e.g., outer preform cladding 18 and the inner preform tube 32), which results in less stress in and around the weld after the welding occurs. So, at this point 56 in time after the laser preheating step 102, the temperature of the material has been increased throughout at least the preheating volume 110.

The laser preheating step 102 occurs throughout a preheating period of time. In embodiments, the preheating period of time is within a range of from 1 second to 10 seconds. For example, the preheating period of time can be 1 second, 2 seconds, 3 seconds, 4 seconds, 5 seconds, 6 seconds, 7 seconds, 8 seconds, 9 seconds, 10 seconds, or within any range bound by any two of those values (e.g., from 3 seconds to 8 seconds, from 4 seconds to 9 seconds, and so on). The preheating period of time can be greater than 10 seconds as well—the values listed are just exemplary.

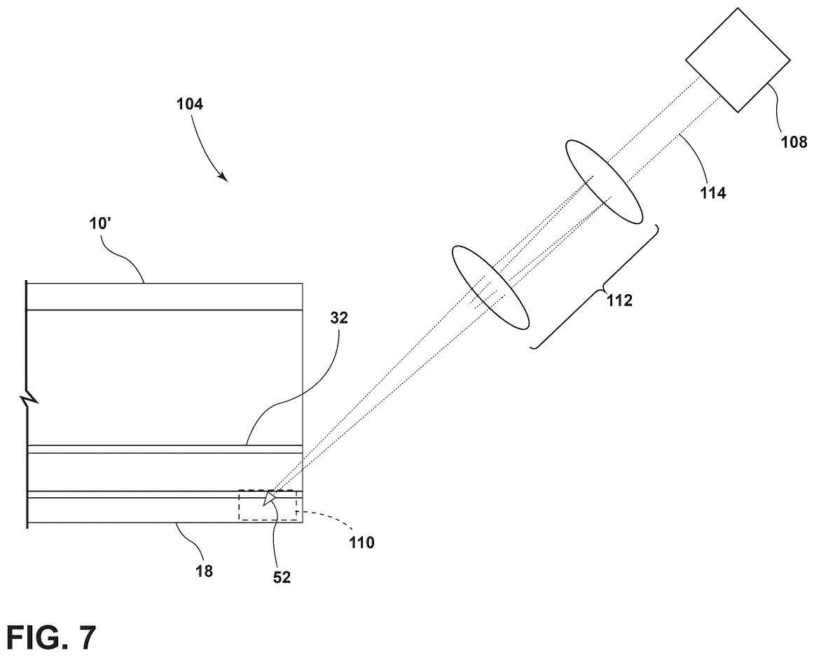

The laser welding step 104 (FIG. 7) includes directing a welding emission 114 from the laser 108 into the preheating volume 110. The welding emission 114 further increases the temperature within a weld volume 52, 54 (e.g., a first weld volume 52), which reduces the viscosity therein. The weld volume 52, 54 is at least partially coextensive with the preheating volume 110. The preheating volume 110 can entirely encompass the weld volume. Because of the welding emission 114, within the weld volume 52, 54, the material of the outer preform cladding 18 and the inner preform tube 32 softens. Upon decreasing in temperature after termination of the welding emission 114, the viscosity increases within the weld volume 52, 54, and the weld forms at the weld volume 52, 54 that join the outer preform cladding 18 and the inner preform tube 32 together. The weld thus formed is one of the first weld volumes 52 when formed proximate the first end 12 of the fiber preform workpiece 10′ or one of the second weld volumes 54 when formed proximate the first end 12 of the fiber preform workpiece 10′.

In embodiments, the laser 108 has a position relative to the preform workpiece 10′ that is substantially the same throughout the laser preheating step 102 and the laser welding step 104. In short, in these embodiments, the laser 108 and the preform workpiece 10′ are not translated relative to each other between the laser preheating step 102 and the laser welding step 104. The lack of translation helps ensure that the preheating volume 110 overlaps if not subsumes the weld volume 52, 54.

As mentioned, the welding emission 114 causes softening of the material, while the preheating emission 106 does not. To achieve that, the laser 108 can emit the welding emission 114 with greater power than the preheating emission 106. In such circumstances, the focusing optics 112 can be held static for the laser preheating step 102 and the laser welding step 104. The power can simply be increased after the laser preheating step 102 to conduct the laser welding step 104.

However, in embodiments, focusing optics 112 are utilized to manipulate the preheating emission 106 differently than welding emission 114. As mentioned, it may be advantageous for the preheating volume 110 to not just overlap but to fully encompass the weld volume 52, 54. To achieve that, the focusing optics 112 can manipulate the preheating emission 106 so that the preheating emission 106 is wider resulting in a relatively increase in the size of the preheating volume 110. To maintain a desired increase in temperature within the preheating volume 110, the power the laser 108 uses for the preheating emission 106 can be increased. Despite the higher power, the power is distributed over a larger preheating volume 110, such that no softening occurs—only the requisite non-softening increase in temperature. After the laser preheating step 102, the focusing optics 112 can be adjusted for the laser welding step 104 to form a weld volume 52, 54 more fully encompassed by the preheating volume 110, and the power adjusted as necessary so that softening occurs to form the weld volume 52, 54.

The laser welding step 104 occurs throughout a welding period of time. The welding period can be greater than the preheating period of time. In embodiments, the welding period of time is within a range of from 1 second to 40 seconds. For example, the welding period of time can be 1 second, 5 seconds, 10 seconds, 15 seconds, 20 seconds, 25 seconds, 30 seconds, 35 seconds, 40 seconds, or within any range bound by any two of those values (e.g., from 10 seconds to 35 seconds, from 15 seconds to 30 seconds, and so on). The welding period of time can be greater than 40 seconds as well—the values listed are just exemplary.

In embodiments, the laser 108 emits the welding emission 114 with a power of less than 170 W. For example, the power for the welding emission 114 can be 80 W, 90 W, 100 W, 110 W, 120 W, 130 W, 140 W, 150 W, 160 W, 170 W, or within any range bound by any two of those values (e.g., from 80 W to 170 W, and so on). The power could be less than 80 W or greater than 170 W, however.

In embodiments, the welding emission 114 from the laser 108 has a wavelength of peak intensity that is within a range of from 5 μm to 11 μm. For example, the wavelength of peak intensity can be 5 μm, 6 μm, 7 μm, 8 μm, 9 μm, 10 μm, 11 μm, or within any range bound by any two of those values (e.g., from 5 μm to 10 μm, from 6 μm to 9 μm, and so on). Silica glasses strongly absorb emissions of such wavelengths. Those values are not meant to be exhaustive. The laser 108 can be a CO₂ laser.

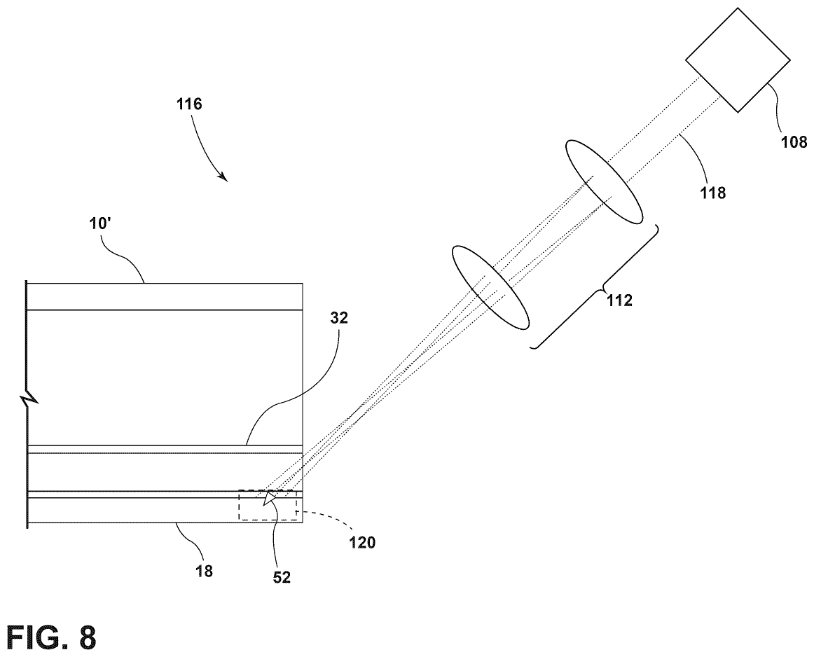

In embodiments, the method 100 includes a laser annealing step 116 (see FIG. 8). The laser annealing step 116 occurs after the laser welding step 104 and after the laser preheating step 102 (if present). The laser annealing step 116 includes directing an annealing emission 118 from the laser 108 into an annealing volume 120 of material of the preform workpiece 10′. The annealing volume 120 at least partially overlaps, and preferably fully encompasses, the weld volume 52, 54 of the laser welding step 104. The annealing emission 118 maintains the temperature of the material within the annealing volume 120 to above an annealing temperature of the material but below the softening temperature. The laser annealing step 116 is a controlled decrease in temperature of the material within the annealing volume 120 from above the softening temperature to below softening temperature. For recall, the laser preheating step 102 increased the temperature of the material where the weld volume 52, 54 would be formed during the laser welding step 104 and thereby decreased the thermal flux that would cause residual stress to form from the weld. If the residual stress is insignificant, then the laser annealing step 116 may not be required. However, in the event that the laser annealing step 116 is performed, the annealing emission 118 maintains the temperature of the material of the annealing volume 120 sufficiently to relieve residual stress that had been generated because of the laser welding step 104. For example, the outer preform cladding 18 proximate the weld volume 52, 54 exhibits a first stress after the laser welding step 104 but before the laser annealing step 116. Then, after the laser annealing step 116, the outer preform cladding 18 proximate the w weld volume 52, 54 exhibits a second stress, which is less than the first stress. The laser annealing step 116 relieves some of the stress accumulated during the laser welding step 104 within the outer preform cladding 18 (and also the inner preform tube) around the weld volume 52, 54 and within the weld volume 52, 54 generally. The laser annealing step 116 does not need to completely eliminate stress resulting from the laser welding step 104 but only to reduce the stress to a level that does not cause crack formation and/or crack growth over time even when an additional external stress is present due to imperfection in the inner preform tube 32 such as bow or mismatch in coefficient of thermal expansion between the inner preform tube 32 and the outer preform cladding 18.

The laser annealing step 116 occurs throughout an annealing period of time. In embodiments, the annealing period of time that is greater than the preheating period of time and is greater than the welding period of time. In embodiments, the annealing period is within a range of from 30 seconds to 180 seconds. For example, the annealing period can be 30 seconds, 35 seconds, 40 seconds, 45 seconds, 50 seconds, 55 seconds, 60 seconds, 65 seconds, 70 seconds, 75 seconds, 80 seconds, 85 seconds, 90 seconds, or within any range bound by any two of those values (e.g., from 60 seconds to 80 seconds, from 65 seconds to 75 seconds, and so on). The annealing period can be less than 30 seconds or greater than 180 seconds—those listed values are merely exemplary.

In embodiments, the annealing emission 118 from the laser 108 has a wavelength of peak intensity that is within a range of from 5 μm to 11 μm. For example, the wavelength of peak intensity can be 5 μm, 6 μm, 7 μm, 8 μm, 9 μm, 10 μm, 11 μm, or within any range bound by any two of those values (e.g., from 5 μm to 10 μm, from 6 μm to 9 μm, and so on). Those values are not meant to be exhaustive.

As mentioned, in embodiments, the position of the laser 108 has relative to the preform workpiece 10′ throughout the laser preheating step 102 and the laser welding step 104 is substantially the same. Similarly, the position of the laser 108 relative to the preform workpiece 10′ can be substantially the same for the laser annealing step 116. In short, in these embodiments, the laser 108 and the preform workpiece 10′ are not translated relative to each other between any one the laser preheating step 102, the laser welding step 104, and the laser annealing step 116. The lack of translation of the laser 108 and the preform workpiece 10′ helps ensure that the annealing volume 120, like the preheating volume 110, overlaps if not subsumes the weld volume 52, 54.

While the preheating emission 106 is intended to raise the temperature of material to above the annealing temperature but below the softening temperature, and the welding emission 114 is intended to raise the temperature of the material further to at least the softening temperature, the annealing emission 118 is intended to maintain the temperature of the material to only about the annealing temperature (below the softening temperature). This can be achieved in several ways. In some instances, the laser 108 emits the welding emission 114 with less power than both the preheating emission 106 and the welding emission 114. Lowering the power of the laser 108 for the welding emission 114 can avoid a need to adjust the focusing optics 112. However, without a change in focusing optics 112, the annealing volume 120 and the weld volume 52, 54 would approximately overlap, and it may be desirable to increasing the annealing volume 120 to relieve residual stress throughout a greater portion of the material surrounding the weld volume 52, 54.

In other instances, focusing optics 112 utilized to manipulate the welding emission 114 are altered to manipulate the annealing emission 118 so that the annealing emission 118 is wider than the welding emission 114. The annealing volume 120 is thus greater than the weld volume 52, 54. As the energy of the annealing emission 118 is diluted over a greater annealing volume 120, the power that the laser 108 uses to generate the annealing emission 118 can be increased and has to be to achieve at least the annealing temperature of the material. In such cases, the laser 108 emits the annealing emission 118 with greater power than the welding emission 114 and, in some embodiments, greater power than both the preheating emission 106 and the welding emission 114. As can be gathered, the focusing optics 112 is an impactful tool for optimization. Feedback of the temperature at the preheating volume 110, the weld volume 52, 54, and the annealing volume 120 as a result of the preheating emission 106, the welding emission 114, and the annealing emission 118 respectively from the laser 108 can be provided by an infrared camera. The focusing optics 112 allow for adjustment of the size of the preheating volume 110, the weld volume 52, 54, and the annealing volume 120. The focusing optics 112 could allow the preheating emission 106 to generate the preheating volume 110 of relatively large size. Then the focusing optics 112 can be adjusted to narrow the welding emission 114 to reduce the size of the weld volume 52, 54 compared to the preheating volume 110. Then the focusing optics 112 can be adjusted yet again to broaden the annealing emission 118 to increase the size of the annealing volume 120 compared to the weld volume 52, 54. The changes of those respective volumes can be accompanied and synchronized with changes to the power the laser 108 uses to generate the respective emissions forming those volumes in order to maintain the required power density.

As described above, each of the first weld volumes 52 and the second weld volumes 54 have the vortex or conical shape preferably extending to a point 56 inward from the first end 12 or the second end 14, respectively, of the fiber preform 10 and away from the longitudinal axis 16. The preheating emission 106, the welding emission 114, and the annealing emission 118 (if made) all impinge upon the preform workpiece 10′ at an angle 122 that is acute and not orthogonal relative to the longitudinal axis 16 and the tube axis 38. This path of the welding emission 114 promotes a vortex or conical shape extending to a point 56 for the first weld volumes 52 and the second weld volumes 54 respectively. The acute angle 122 of the welding emission 114 results in the first weld volumes 52 and the second weld volumes 54 forming a barb-like structure that resists a pulling force on the inner preform tube 32 away from the outer preform cladding 18.

In embodiments, the method 100 further includes a translating step 124 and thereafter repeating performances of the laser preheating step 102, the laser welding step 104, and optionally the laser welding step 104. The translating step 124 and performing that cycle of steps again forms the additional first weld volume 52a inward of the first weld volume 52 formed to fuse the inner preform tube 32 and the outer preform cladding 18. The translating step 124 includes translating the preform workpiece 10′ relative to the laser 108 so that the additional first weld volume 52a resulting from the repeat performance of the laser welding step 104 would be disposed inward of the first weld volume 52 (e.g., away from the first end 12 of the fiber preform workpiece 10′). Thereafter the laser preheating step 102, the laser welding step 104, and the laser annealing step 116 (if desired) are performed resulting in the additional first weld volume 52b. The translating step 124 and the repeat performances can be done repeatedly to result in as many additional first weld volumes 52n desired to fuse the inner preform tube 32 and the outer preform cladding 18 together. Because the additional first weld volumes 52a, 52b, . . . 52n are disposed slightly further away from the laser 108 than the first weld volume 52, the power that the laser 108 uses for each of the laser preheating step 102, the laser welding step 104, and the laser annealing step 116 can be increased relative to the laser 108 power used for those steps in connection with the first weld volume 52.

When the preform workpiece 10′ includes more than one inner preform tube 32 to weld to the outer preform cladding 18, the method 100 further includes a rotating step 126 that includes rotating the preform workpiece 10′ relative to the laser 108 about the longitudinal axis 16 of the fiber preform workpiece 10′. The rotating step 126 positions the next of the inner preform tubes 32 so that a subsequent performance of the laser welding step 104 would form the first weld volume 52 to fuse the inner preform tube 32 and the outer preform cladding 18 together. Implementation of the laser preheating step 102, the laser welding step 104, and the laser annealing step 116 (if desired) are performed thus forming the first weld volume 52. The translating step 124 and repeat performances of the laser preheating step 102, the laser welding step 104, and the laser annealing step 116 (if desired) can then be performed to form the additional first weld volumes 52a, 52b, . . . 52n. The steps of this paragraph can be repeated until each of the inner preform tubes 32 of the preform workpiece 10′ are welded to the outer preform cladding 18 with the first weld volume 52 and any additional first weld volumes 52a, 52b, . . . 52n.

The above steps are repeated as necessary to form the second volumes 54 and the additional second weld volumes 54a, 54b, . . . 54n as desired to weld each of the inner preform tubes 32 to the outer preform cladding 18 at the second end 14 of the preform workpiece 10′. Note that two lasers 108 could be used simultaneously-one emitting into the first end 12 of the preform workpiece 10′ and the other emitting at the second end 14 of the preform workpiece 10′. Alternatively, one laser 108 could be utilized, in which case the preform workpiece 10′ is translated relative to the laser 108 after the inner preform tubes 32 are welded to the outer preform cladding 18 at the first end 12. In event, the method 100 includes repeating cycles of the laser preheating step 102, the laser welding step 104, the laser annealing step 116 (if desired), and the translation step 124 as necessary to form, for each of the inner preform tubes 32, the second weld volume 54 at least one of the additional second weld volumes 54a, 54b, . . . 54n inward of the second weld volume 54 that weld the outer preform cladding 18 and the inner preform tube 32 together proximate a second end 14 of the fiber preform workpiece 10′.

An anti-resonant hollow core optical fiber (not separately illustrated) can then be drawn from the fiber preform 10 described here, such as the fiber preform 10 made pursuant to the method 100 of the present disclosure.

The fiber preform 10 and the method 100 of the present disclosure address the problems set forth in Background, in a variety of ways. Among them, the inclusion of the laser preheating step 102 and, if desired, the laser annealing step 116 of the method 100 reduces residual stress within the fiber preform 10 in and around the first weld volumes 52, the additional first weld volumes 52a, 52b, . . . 52n, the second weld volumes 54, and the additional second weld volumes 54a, 54b, . . . 54n compared to if no laser preheating step 102 and no laser annealing step 116 were preformed. Thus, cracks are less likely to develop, even after handing of the fiber preform 10. The laser preheating step 102 and the laser preheating step 102 (if performed) utilize adjustments in power of the laser 108 and/or changes focusing optics 112 to preheat and anneal. Open flame is incapable of such precision and those steps have never been disclosed in connection with laser welding. Second, the method 100 utilizes the laser 108 and thus avoids the use of an open flame that more readily causes contamination within the cladding interior 26 and distortion of the components of the fiber preform 10. The welding emission 114 from the laser 108 resulting in the various weld volumes 52, 54 is relatively small compared the broader heat zones from contact of the fiber preform 10 with open flame and thus avoids the possibility of distortion of the components such as the inner preform tube 32 from dimensional instability.

### EXAMPLES

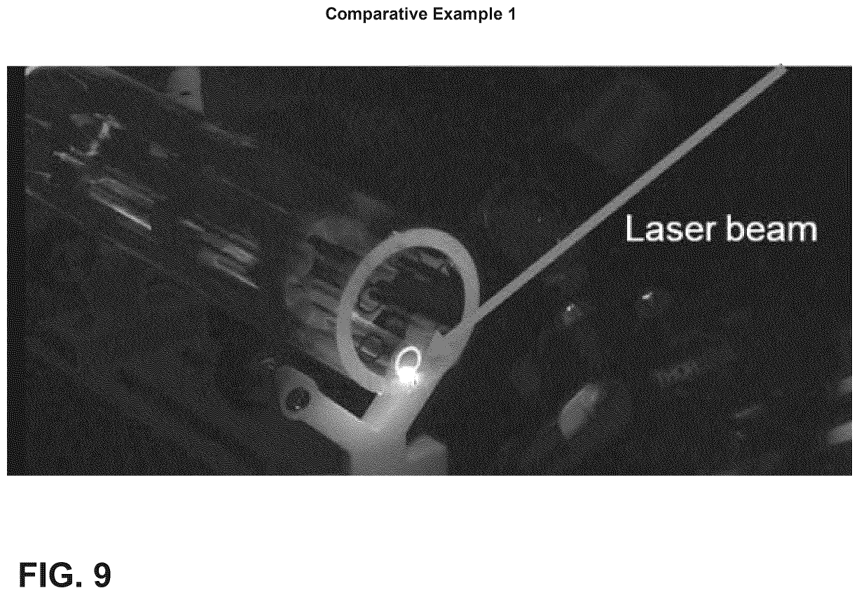

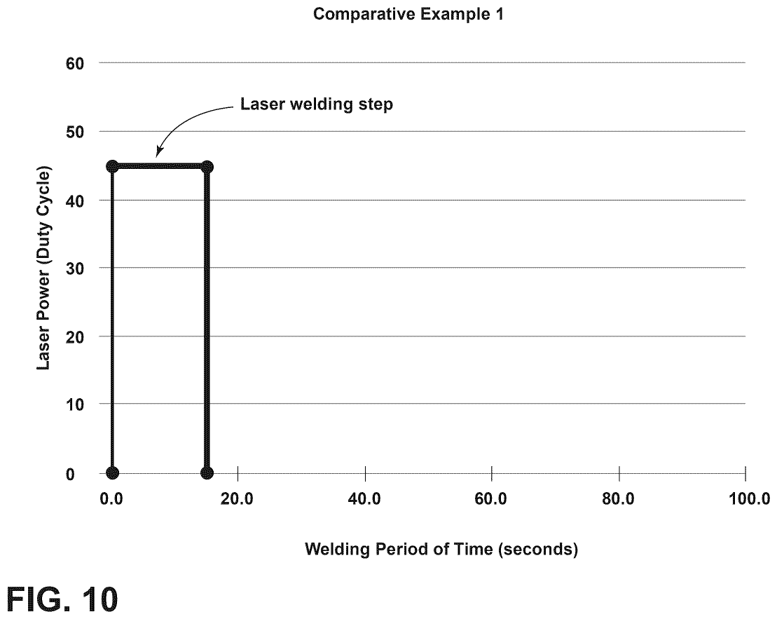

Comparative Example 1—For Comparative Example 1, a laser welding step directed a welding emission into a preform workpiece to weld an inner preform tube to an outer cladding at both the first end and the second end of the preform workpiece. Neither a laser preheating step nor a laser annealing step were performed. Duration of the welding period typically did not exceed 40 seconds (typically withing a range of 15 seconds to 20 seconds) and with a power for the welding emission of less than 170 W at 10.6 μm wavelength. The welding emission entered the preform workpiece first through the inner preform tube at an acute angle relatively to the longitudinal axis and the tube axis. This is depicted in the image of reproduced at FIG. 9. A total of three welds were made at least of the first end and the second end, as a triple weld. The laser made the welding emission with a power in terms of duty cycle of 45% (approximate 140 W) for 15 seconds. A graph of the laser power as a function of the welding period of time is reproduced at FIG. 10. For purposes of this comparative example and the comparative example and examples that follow, the duty cycle of the associated graphs at a given laser frequency of 10 kHz can be converted to power in Watts using the data table below.

Duty Cycle (at 10 kHz) to Watts Conversion

| Duty Cycle (%) | Watts |
|---|---|
| 10 | 29.6 |
| 20 | 66.3 |
| 25 | 84 |
| 30 | 97 |
| 35 | 112 |
| 40 | 125.7 |
| 45 | 140.1 |
| 50 | 150 |
| 55 | 160 |
| 60 | 173.2 |
| 70 | 190 |
| 80 | 200 |

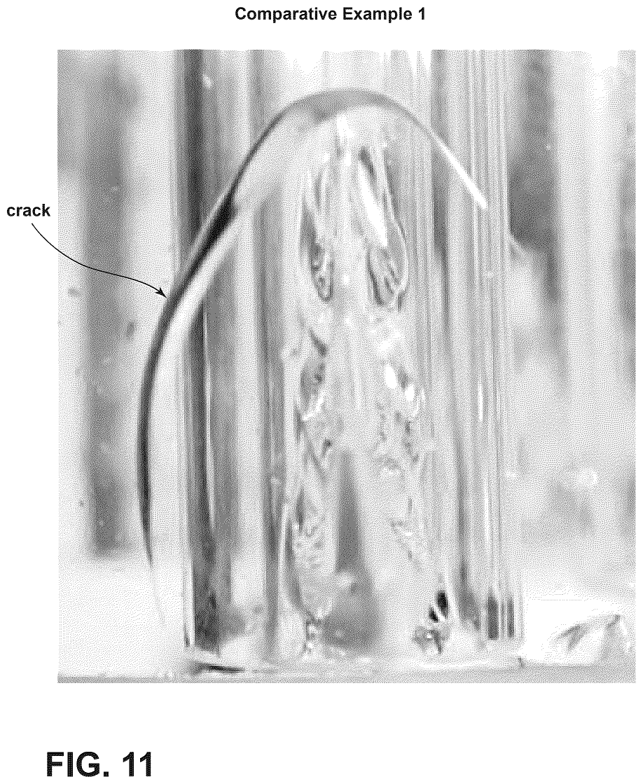

Experience has demonstrated such a welding approach at both the first side and the second side of the preform workpiece produces a fiber preform that fails from 10% to 20% of the time during subsequent handling and before optical fiber can be drawn therefrom. Such failure rates are not acceptable. The failure is typically the result of cracking around the welds. An image showing a typical crack into the outer cladding of the fiber preform proximate the welds, which occurred after less than 24 hours from the welding, is reproduced at FIG. 11. Cracks typically appeared proximate of welds of inner preform tubes having excessive bow, eccentricity, or thickness variations, which can result in additional external stress applied to the weld volume leading to creation of the area of high tension around it. This extra tension stress combined with the laser-induced stress can cause formation of the crack around the weld volume and induce small crack growth over time.

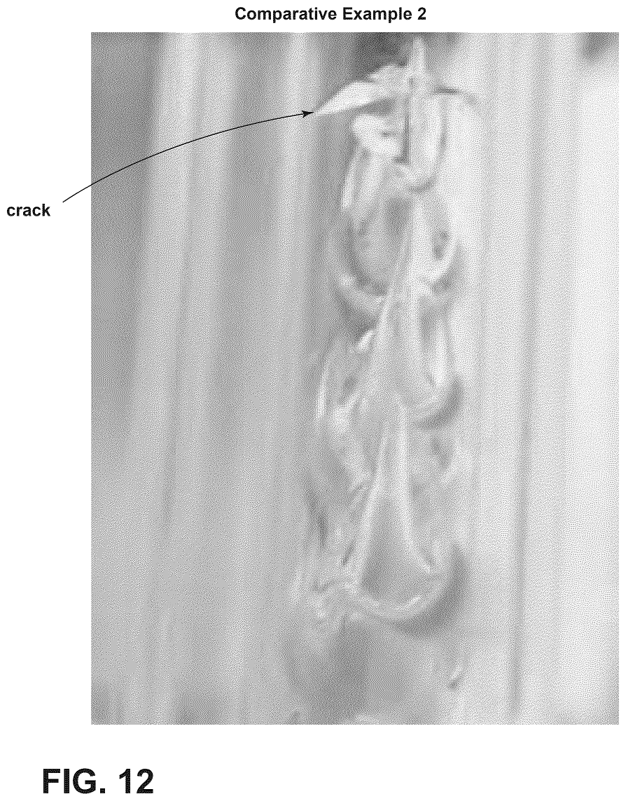

Comparative Example 2—For Comparative Example 2, a laser welding step was performed three times to weld an inner preform tube to an outer cladding at both the first end and the second end of the preform workpiece, resulting in triple welded volumes at each end. While a laser annealing step of short duration was performed, no laser preheating step was performed. While failure of the preform workpiece after such welding with the shortened laser annealing step was relatively rare (and occurred less often than observed for Comparative Example 1), failures did occur. An image showing a crack into the outer cladding of the fiber preform proximate the welds, which occurred after more than 24 hours from the welding, is reproduced at FIG. 12.

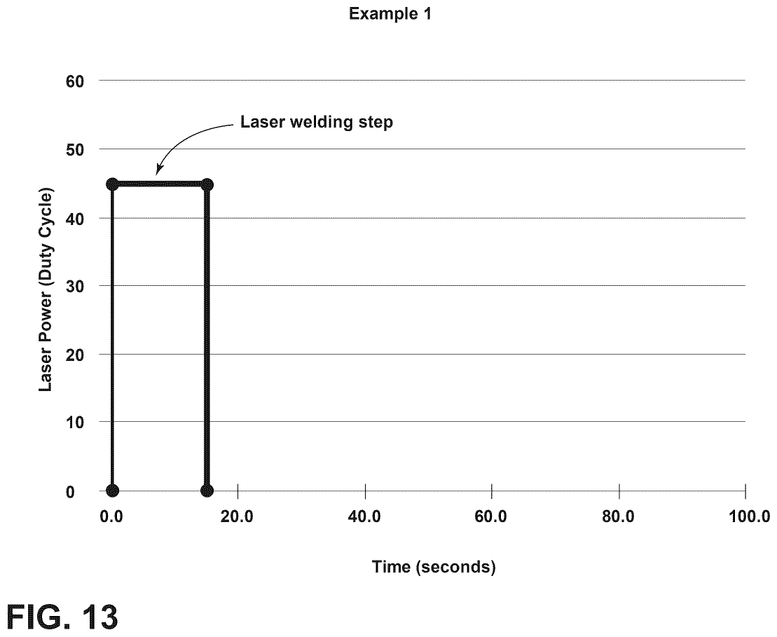

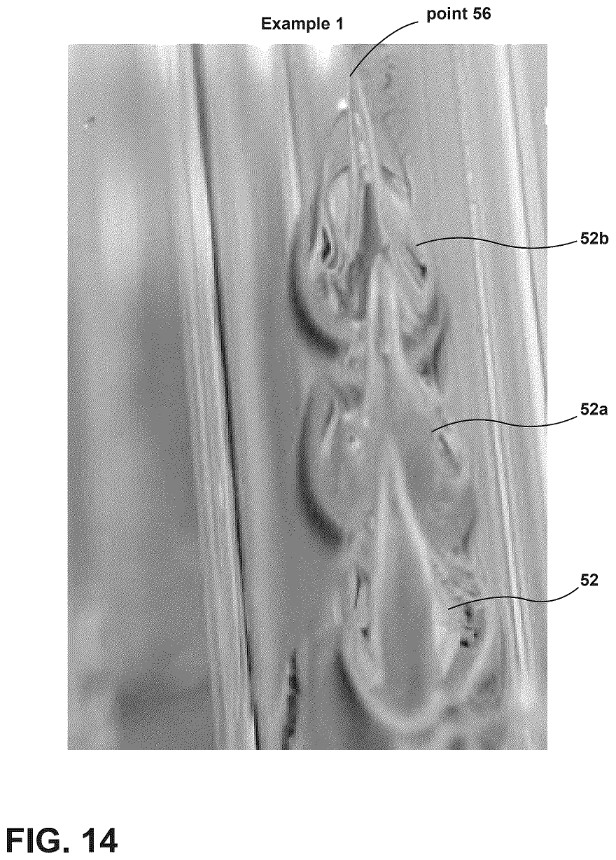

Example 1—For Example 1, a preform workpiece was subjected to an embodiment of the method of the present disclosure. More particularly, at each of the first end and the second end of the preform workpiece, an inner preform tube and an outer preform cladding were subjected to a laser preheating step, a laser welding step, and a laser annealing step. For the laser preheating step, the laser used a power in terms of duty cycle of 35% (approximately 112 W) and emitted the preheating emission for 5 seconds. For the laser welding step, the power of the laser was increased to 45% in terms of duty cycle (approximately 140 W) and emitted the welding emission for 15 seconds. For the laser annealing step, the power of the laser was reduced to 25% in terms of duty cycle (approximately 84 W) and emitted the annealing emission for 60 seconds. A graph of the power of laser emission as a function of time of emission for each of Example 1 is reproduced at FIG. 13. Fiber preforms so produced exhibited a 100% process yield (e.g., no failures) with no cracks observed in any component of the fiber preform. An image showing the welds without any cracking proximate the welds, even after resting for more than 240 hours from the welding, is reproduced at FIG. 14. All experiments showed that if cracking does not appear in the first twenty-four hours after welding, then cracking would likely never appear. While the image was taken after 250 hours, resting time has exceeding 3 months without cracking.

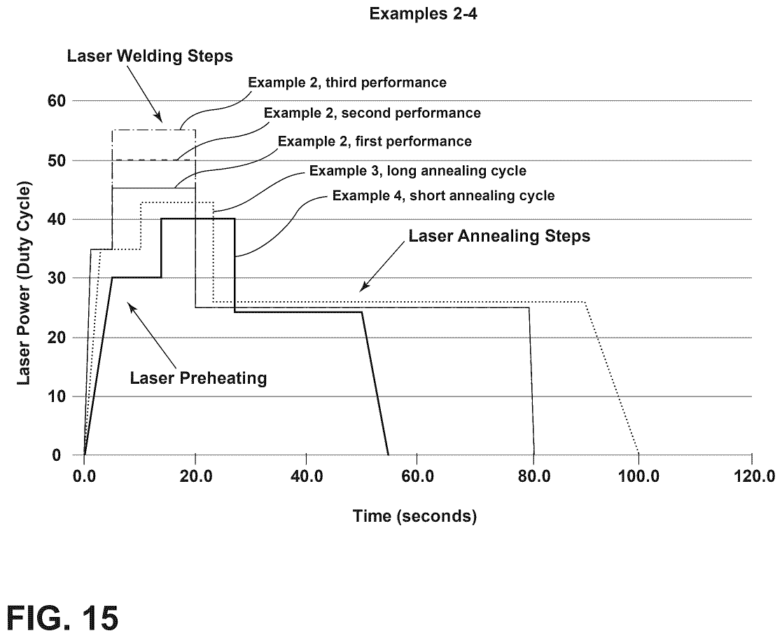

Examples 2-4—For Example 2, a preform workpiece again was subjected to the method of the present disclosure in the same manner as Example 1. The distinction is that the sequence of the laser preheating step, the laser welding step, and the laser annealing step was repeated three times at each end of the preform workpiece to form three weld volumes. The power of the laser for the welding emission for the first weld in terms of duty cycle was 45% (approximately 140 W), then raised to 50% in terms of duty cycle (approximately 150 W) for the second performance of the welding emission, and then finally raised to 55% in terms of duty cycle (approximately 160 W) for the third performance of the welding emission. A graph of the power of laser emission as a function of time of emission for each of Examples 2-4 is reproduced at FIG. 15.

For Example 3, a preform workpiece again was subjected to the method of the present disclosure in the same manner as Example 1. The relevant distinction is that the laser annealing was conducted for a shorter annealing period of time—in this instance 25 seconds compared to 60 seconds for Example 1.

For Example 4, a preform workpiece again was subjected to the method of the present disclosure in the same manner as Example 1. The relevant distinction is that the laser annealing was conducted for a longer annealing period of time—in this instance 25 seconds compared to 60 seconds for Example 1.

Examples 2-4 show that power and the various emission periods of time (annealing period of time) are optimizable. Characteristics of the components of one preform workpiece can be different than characteristics of another preform workpiece, depending on the design and intended functionality of the hollow core optical fiber to be drawn from the fiber preform made from the preform workpiece. Examples of such differing characteristics include the diameter of the inner preform tube, the thickness of the inner preform tube, the compositions of the inner preform tube and the outer preform cladding. Specific laser process variables, such as frequency of the laser emissions, duty cycle, the preheating period of time, the welding period of time, the annealing period of time, power, and so on are all tunable as the characteristics of the components differ from one preform workpiece to another.

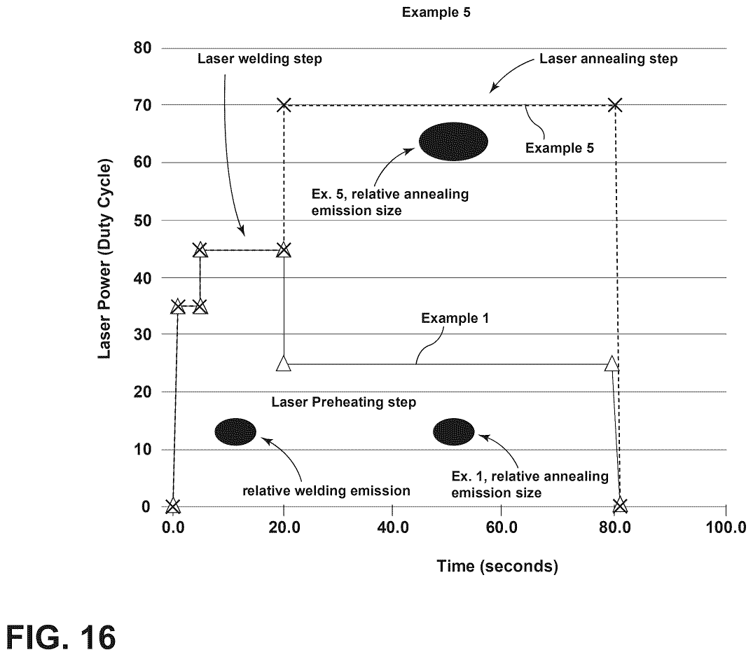

Example 5—For Example 5, a preform workpiece again was subjected to the method of the present disclosure in the same manner as Example 1. The relevant distinctions are (i) that focusing optics manipulated the annealing emission to be wider for interaction with the preform workpiece compared to the welding emission and (ii), because the intensity of the emission was spread over a larger area, the power of the laser for the annealing emission was increased to 70% in terms of duty cycle (approximately 190 W) compared to 25% in terms of duty cycle (approximately 84 W) for the annealing emission of Example 1. A graph of the power of laser emission as a function of time of emission for each of Examples 5 is reproduced at FIG. 16. Example 5 shows that focusing optics can help optimize the various steps of the method of the present disclosure.

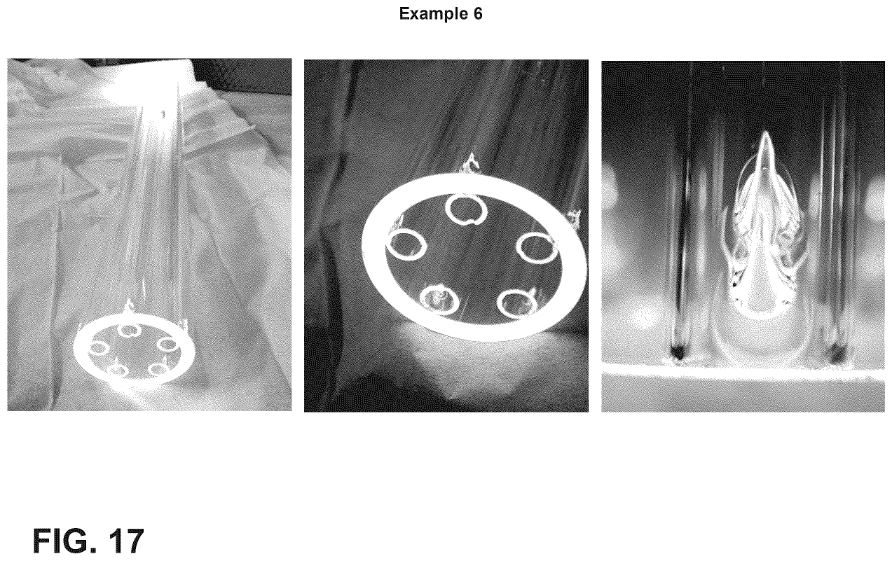

Example 6—For Example 6, a preform workpiece again was subjected to the method of the present disclosure in the same manner as Example 1. The relevant distinctions are (i) five inner cladding tubes were welded to the outer preform cladding and (ii) a pair of weld volumes were formed at both the first side and the second side of the preform workpiece for each to attach each of the inner cladding tubes to the outer preform cladding. Images of the resulting fiber preform, the first end of the fiber preform, and one of the pair of weld volumes are reproduced at FIG. 17.

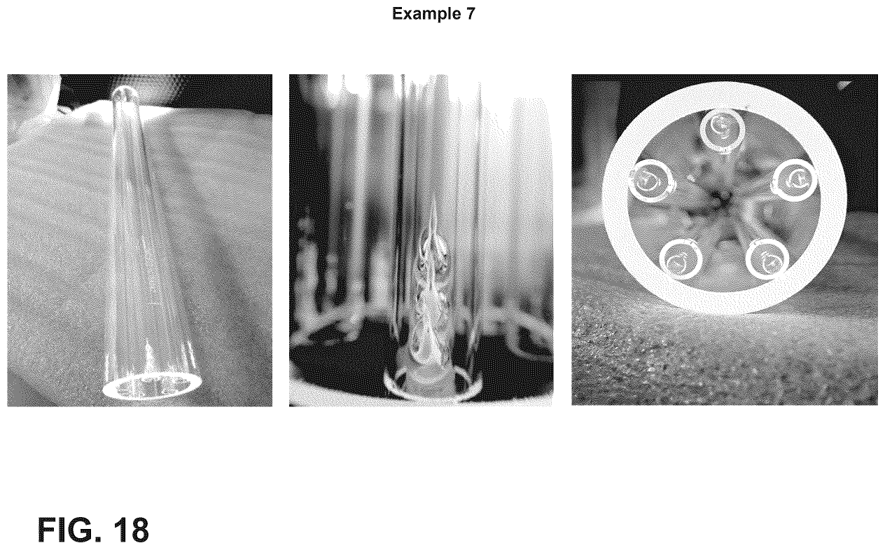

Example 7—For Example 6, a preform workpiece again was subjected to the method of the present disclosure in the same manner as Example 5. The relevant distinctions are (i) preform capillaries were included, each of the preform capillaries disposed within a different one of the five inner cladding tubes and (ii) a triplet of weld volumes welding each of the inner cladding tubes, with a preform capillary therein and also welded, to the outer preform cladding. Images of the nested fiber preform, the first end of the nested fiber preform, and one of the triplets of weld volumes are reproduced at FIG. 18.

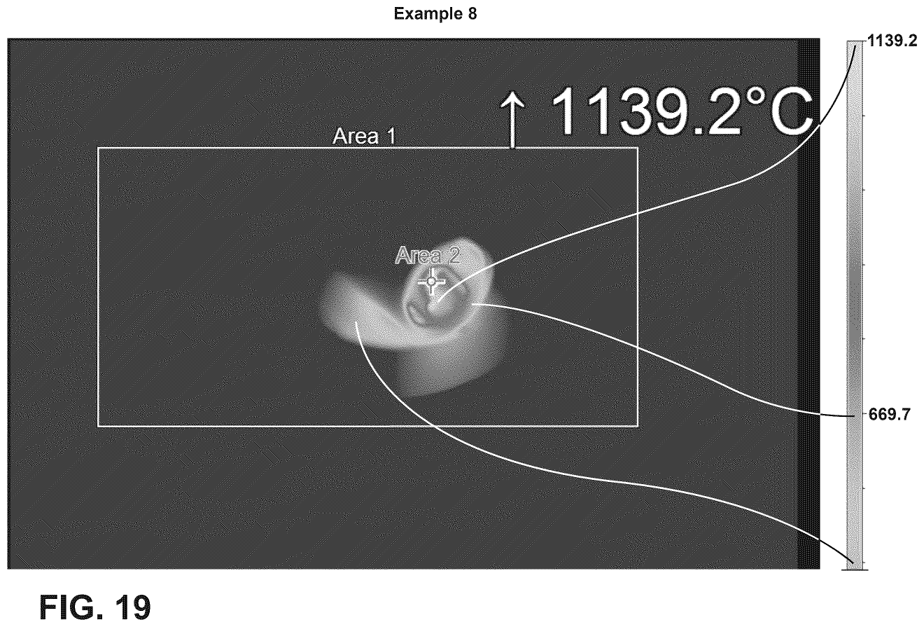

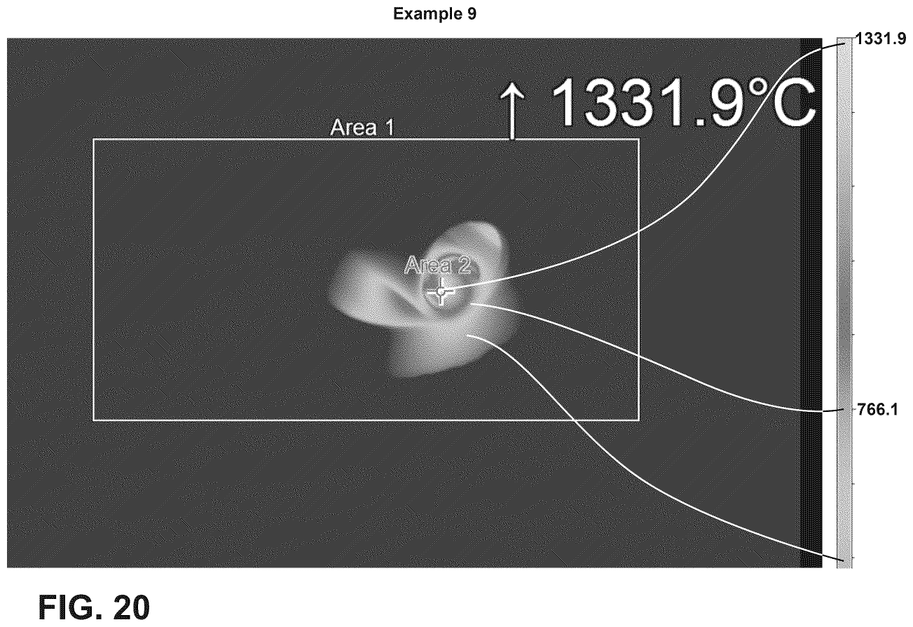

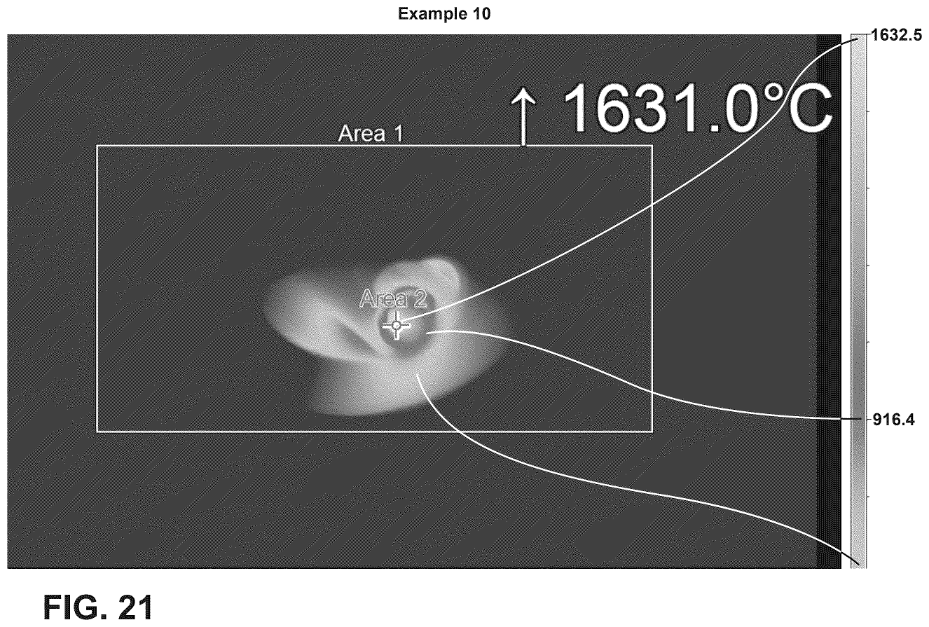

Examples 8-10—For each of Examples 8-10, a preform workpiece was subject to a laser preheating step, a laser welding step, and a laser annealing step of the method of the present disclosure. During the laser annealing step, an infrared camera was utilized to determine a temperature profile within and proximate to the annealing volume (overlapping the weld volume just previously formed). The laser utilized powers in terms of duty cycle of 50% (approximately 150 W), 70% (approximately 130 W), and 80% (approximately 200 W) to form the annealing emissions of Examples 8, 9, and 10, respectively. The annealing emissions caused the materials of Examples 8, 9, and 10 to have peak temperatures of about 1139° C., 1332° C., and 1631° C., respectively. Images of the temperature as a function of position at the material were captured. Those images are reproduced as FIGS. 19-21.

It will be apparent to those skilled in the art that various modifications and variations can be made without departing from the spirit or scope of the claims.

What is claimed is:

1. A fiber preform comprising:
a first end, a second end, a longitudinal axis extending from the first end to the second end;
an outer preform cladding through which the longitudinal axis extends, the outer preform cladding comprising an inner surface disposed radially around the longitudinal axis;
inner preform tubes welded to the outer preform cladding at the inner surface of the outer preform cladding, wherein each of the inner preform tubes comprises (i) a tube axis extending therethrough parallel to the longitudinal axis of the fiber preform, (ii) an inner surface extending radially around the tube axis, and (iii) an outer surface facing away from the tube axis, and wherein the inner preform tubes collectively define a preform core that extends radially from the longitudinal axis and that is tangential to the outer surfaces of the inner preform tubes; and
first weld volumes, each of the first weld volumes welding a different one of the inner preform tubes to the outer preform cladding proximate the first end of the fiber preform; wherein, each of the first weld volumes has a vortex or conical shape.

2. The fiber preform of claim 1, wherein
the outer preform cladding and the inner preform tubes all comprise one or more of silica, doped silica, fluorine-doped silica, fluorine-doped borosilicate, borosilicate, soda-lime glass, and alumina-silicate.

3. The fiber preform of claim 1, further comprising:
preform capillaries disposed within the inner preform tubes, each of the preform capillaries disposed within a different one of the inner preform tubes, wherein each of the preform capillaries comprises (i) a capillary axis extending therethrough parallel to the longitudinal axis of the fiber preform, (ii) an inner surface extending radially around the capillary axis, and (iii) an outer surface facing away from the tube axis,
wherein, each of the first weld volumes further welds a different one of the preform capillaries to the inner preform tube within which the preform capillary is disposed proximate the first end of the fiber preform.

4. The fiber preform of claim 1, further comprising:
second weld volumes, each of the second weld volumes welding a different one of the inner preform tubes to the outer preform cladding proximate the second end of the fiber preform,
wherein, each of the second weld volumes has a vortex or conical shape.

5. The fiber preform of claim 4, further comprising:
preform capillaries disposed within the inner preform tubes, each of the preform capillaries disposed within a different one of the inner preform tubes, wherein each of the preform capillaries comprises (i) a capillary axis extending therethrough parallel to the longitudinal axis of the fiber preform, (ii) an inner surface extending radially around the capillary axis, and (iii) an outer surface facing away from the tube axis,
wherein, each of the first weld volumes further welds a different one of the preform capillaries to the inner preform tube within which the preform capillary is disposed proximate the first end of the fiber preform, and
wherein, each of the second weld volumes further welds a different one of the preform capillaries to the inner preform tube within which the preform capillary is disposed proximate the second end of the fiber preform.

6. A method of manufacturing a fiber preform comprising:
a laser preheating step comprising directing a preheating emission from a laser into an outer preform cladding and an inner preform tube of a preform workpiece, the inner preform tube disposed at least partially within the outer preform cladding, to increase temperature within a preheating volume that extends into both the outer preform cladding and the inner preform tube; and
a laser welding step, occurring after the laser preheating step, the laser welding step comprising directing a welding emission from the laser into the preheating volume to further increase temperature and decrease viscosity within a weld volume that, upon decreasing in temperature, welds the outer preform cladding and the inner preform tube together,
wherein, the weld volume of the laser welding step at least partially overlaps with the preheating volume of the laser preheating step.

7. The method of claim 6, wherein
the laser preheating step occurs throughout a preheating period of time, and
the preheating period of time is within a range of from 1 second to 10 seconds.

8. The method of claim 6, wherein
the laser emits the welding emission with greater power than the preheating emission.

9. The method of claim 6, wherein
the laser welding step occurs throughout a welding period of time that is greater than the preheating period of time, and
the welding period of time is within a range of from 5 seconds to 40 seconds.

10. The method of claim 6, wherein
the laser emits the welding emission with a power of less than 170 W, and
the welding emission from the laser has a wavelength of peak intensity that is within a range of from 5 μm to 11 μm.

11. The method of claim 6, wherein
upon the decreasing in temperature, the weld volume has a vortex or conical shape.

12. The method of claim 6, further comprising:
a laser annealing step, occurring after the laser welding step, the laser annealing step comprising directing an annealing emission from the laser into an annealing volume that at least partially overlaps the weld volume of the laser welding step, the annealing emission maintaining a temperature of material within the annealing volume to above an annealing temperature but below a softening temperature.

13. The method of claim 12, wherein
the laser preheating step occurs throughout a preheating period of time,
the laser welding step occurs throughout a welding period of time,
the laser annealing step occurs throughout an annealing period of time that is greater than the preheating period of time and greater than the welding period of time,
the annealing period is within a range of from 60 seconds to 90 seconds, and
the annealing emission from the laser has a wavelength of peak intensity that is within a range of from 5 μm to 11 μm.

14. The method of claim 12, wherein
the laser emits the annealing emission with greater power than both the preheating emission and the welding emission.

15. The method of claim 12, wherein
the fiber preform workpiece comprises a longitudinal axis extending through the outer preform cladding,
the inner preform tube comprises a tube axis that is substantially parallel to the longitudinal axis of the fiber preform workpiece, and
the preheating emission, the welding emission, and the annealing emission all impinge upon the preform workpiece at an angle that is acute and not orthogonal relative to the longitudinal axis and the tube axis.

16. The method of claim 12, further comprising:
a translating step comprising translating the preform workpiece relative to the laser so that an additional first weld volume resulting from a repeat performance of the laser welding step would be disposed proximate the first end of the fiber preform workpiece inward of the first end from the first weld volume closest thereto; and
repeating performances of (i) the laser preheating step, (ii) the laser welding step to form the additional first weld volume inward from the first weld volume, and (iii) the laser annealing step.

17. A method of manufacturing a fiber preform comprising:
a laser welding step comprising directing a welding emission from a laser into an outer preform cladding and an inner preform tube of a preform workpiece, the inner preform tube disposed at least partially within the outer preform cladding, to increase temperature within a weld volume that extends into both the outer preform cladding and the inner preform tube; and
a laser annealing step, occurring after the laser welding step, the laser annealing step comprising directing an annealing emission from the laser into an annealing volume that at least partially overlaps the weld volume of the laser welding step, the annealing emission maintaining a temperature of material within the annealing volume to above an annealing temperature but below a softening temperature.

18. The method of claim 17, wherein
the laser welding step occurs throughout a welding period of time,
the laser annealing step occurs throughout an annealing period of time that greater than the welding period of time,
the annealing period is within a range of from 60 seconds to 90 seconds, and
the annealing emission from the laser has a wavelength of peak intensity that is within a range of from 5 μm to 11 μm.

19. The method of claim 17, wherein
the laser emits the annealing emission with greater power than the welding emission.

20. The method of claim 17, wherein
upon a decrease in temperature from the annealing temperature the weld volume has a vortex or conical shape.
